(19) United States
(12) Patent Application Publication
(10) Pub. No.: US 2021/0011486 A1
(43) Pub. Date: Jan. 14, 2021

(54) CHARGING MANAGEMENT SYSTEM

(71) Applicant: TOYOTA JIDOSHA KABUSHIKI KAISHA, Toyota-shi (JP)

(72) Inventors: Ikuo OHTA, Toyota-shi (JP); Hideshi MIZUTANI, Toyota-shi (JP); Atsushi SAJIKI, Okazaki-shi (JP); Takao INATA, Tokyo-to (JP); Yohei TANIGAWA, Toyota-shi (JP); Atsushi NAKAJIMA, Kariya-city (JP); Atsuo KOMATSUBARA, Nagakute-shi (JP)

(21) Appl. No.: 16/922,249

(22) Filed: Jul. 7, 2020

(30) Foreign Application Priority Data
Jul. 8, 2019 (JP) 2019-126726

(51) Int. Cl. G05D 1/02; G08G 5/00; B60L 53/66

(52) U.S. Cl. CPC G05D 1/0287; B60L 53/66; G05D 1/0217; G08G 5/003

(57) ABSTRACT

A charging management system capable of reducing congestion of charging electric vehicles in an airport and improving the working efficiency in the airport is provided. A charging management system includes: a collection unit configured to collect departure and arrival information and information regarding amounts of loads of departing and arriving flights; a planning unit configured to create a working plan of electric vehicles working in the airport based on the information collected by the collection unit; and a determination unit configured to determine charging timings of the respective electric vehicles based on the working plan created by the planning unit.

### CROSS REFERENCE TO RELATED APPLICATIONS

This application is based upon and claims the benefit of priority from Japanese patent application No. 2019-126726, filed on Jul. 8, 2019, the disclosure of which is incorporated herein in its entirety by reference.

### BACKGROUND

The present disclosure relates to a charging management system.

Techniques for improving efficiency of logistics in airports have been under discussion. Japanese Unexamined Patent Application Publication No. 2002-321699 discloses a technique for connecting an air cargo holding area in an airport terminal building with an aircraft parking area by an air cargo conveyor mechanism provided underground and further connecting the ground level and a loading/unloading position for the air cargo conveyor mechanism by means of air cargo elevators, thereby conveying air cargo underground.

### SUMMARY

Incidentally, a plurality of electric vehicles (EVs) have been used for working in airports. Currently, however, management of charging timings of the plurality of electric vehicles working in the airport has not been performed. Therefore, when the charging timings of the plurality of EVs working in the airport overlap one another, this causes congestion of charging, which causes the working efficiency to be reduced. The reduction in working efficiency needs to be compensated for by increasing the number of electric vehicles held in the airport.

The present disclosure has been made in view of the aforementioned background and aims to provide a charging management system capable of reducing congestion of charging electric vehicles in an airport and improving the working efficiency in the airport.

A charging management system according to one embodiment of the present disclosure includes: a collection unit configured to collect departure and arrival information and information regarding amounts of loads of departing and arriving flights; a planning unit configured to create a working plan of electric vehicles working in an airport based on the information collected by the collection unit; and a determination unit configured to determine charging timings of the respective electric vehicles based on the working plan created by the planning unit.

The charging timings of the respective electric vehicles are determined based on the working plan created by the planning unit, whereby it is possible to reduce congestion of charging electric vehicles in the airport and improving the working efficiency in the airport. Then by improving the working efficiency in the airport, the number of electric vehicles held in the airport can be eventually reduced.

Further, the working plan may include information on working areas and working periods planned in the respective electric vehicles, and the determination unit may take into account, when determining the charging timings of the respective electric vehicles, the working periods and distances between a charging station and the respective working areas where the respective electric vehicles work in the working periods in the respective electric vehicles. The working periods and the distances between the charging station and the respective working areas where the respective electric vehicles work in the working periods in the respective electric vehicles are extremely important information when the charging timings of the respective electric vehicles are determined. In view of these information items, it is possible to reduce congestion of charging electric vehicles in the airport and improving the working efficiency in the airport.

Further, the determination unit may take into account battery capacities of the respective electric vehicles when it determines the charging timings of the respective electric vehicles. The battery capacities of the respective electric vehicles are important information when the charging timings of the respective electric vehicles are determined. By taking into account this information, it is possible to reduce congestion of charging electric vehicles in the airport and improving the working efficiency in the airport.

According to the present disclosure, it becomes possible to reduce congestion of charging electric vehicles in an airport and improving working efficiency in the airport.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing a configuration of a charging management system according to an embodiment;

FIG. 2 is a flowchart showing a flow of processing of the charging management system according to the embodiment;

FIG. 3 is a schematic view showing one example of working plans created by a planning unit of the charging management system according to this embodiment;

FIG. 4 is a schematic view for describing distances between a charging station and respective working areas in an airport;

FIG. 5 is a list indicating information that a determination unit of the charging management system according to this embodiment takes into account when it determines charging timings of respective electric vehicles; and

FIG. 6 is a list indicating one example of the charging timings of the respective electric vehicles determined by the determination unit of the charging management system according to this embodiment.

### DESCRIPTION OF EMBODIMENTS

Hereinafter, the present disclosure will be described based on the following embodiment. However, the disclosure set forth in claims is not limited to the following embodiment. Moreover, it is not absolutely necessary to provide all the configurations to be described in the following embodiment as means for solving the problems. The following descriptions and the drawings are omitted and simplified as appropriate for the sake of clarity of description. Throughout the drawings, the same elements are denoted by the same reference symbols, and overlapping descriptions are omitted as appropriate.

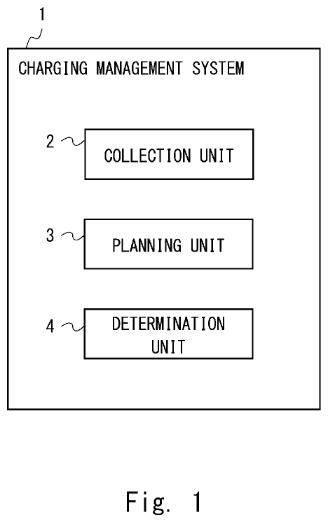

First, a configuration of a charging management system according to this embodiment will be described. FIG. 1 is a block diagram showing a configuration of a charging management system 1. As shown in FIG. 1, the charging management system 1 includes a collection unit 2, a planning unit 3, and a determination unit 4.

The collection unit 2 collects departure and arrival information and information regarding amounts of loads of departing and arriving flights. The planning unit 3 creates a working plan of electric vehicles working in an airport based on the information collected by the collection unit 2. The determination unit 4 determines charging timings of the respective electric vehicles based on the working plan that the planning unit 3 has created.

Next, a flow of processing of the charging management system 1 will be described below. In the following description, FIG. 1 is also referred to as appropriate.

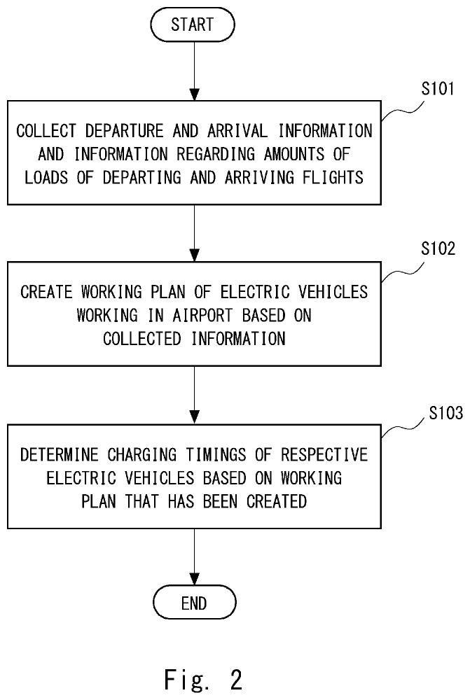

FIG. 2 is a flowchart showing a flow of processing of the charging management system 1. As shown in FIG. 2, first, the collection unit 2 collects the departure and arrival information and the information regarding the amounts of loads of departing and arriving flights (Step S101). Next, the planning unit 3 creates the working plan of the electric vehicles working in the airport based on the collected information (Step S102). Next, the determination unit 4 determines the charging timings of the respective electric vehicles based on the working plan that has been created (Step S103).

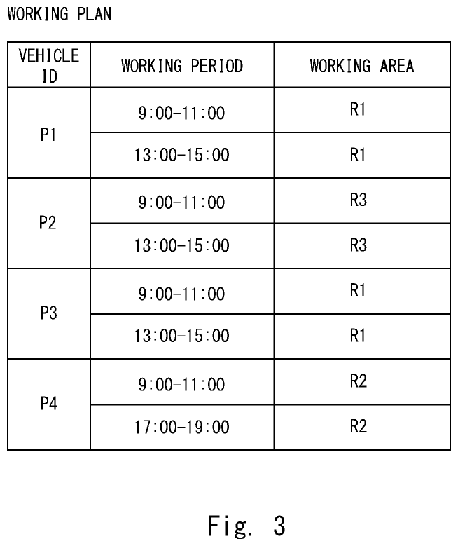

FIG. 3 is a schematic view showing one example of working plans that the planning unit 3 (see FIG. 1) creates. It is assumed that there are four electric vehicles having vehicle IDs P1, P2, P3, and P4 (hereinafter these electric vehicles are referred to as an electric vehicle P1, an electric vehicle P2, an electric vehicle P3, and an electric vehicle P4) that work in the airport. As shown in FIG. 3, the working plan includes information on working areas and working periods planned for the respective electric vehicles. For example, the electric vehicle P1 is planned to conduct working in a working area R1 from 9:00 to 11:00 and conduct working in the working area R1 from 13:00 to 15:00.

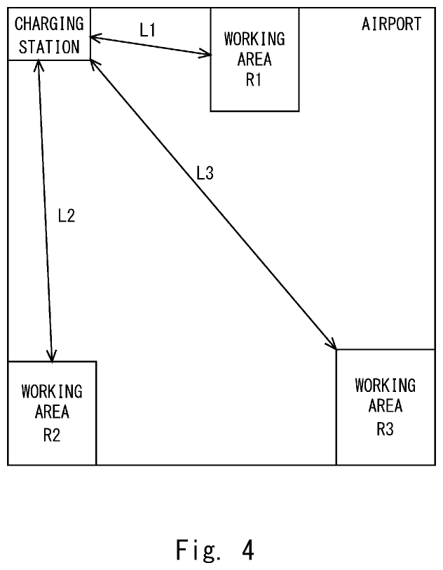

The determination unit 4 shown in FIG. 1 takes into account the working periods and the distances between the charging station and the working areas where the working is conducted in the above working periods in the respective electric vehicles when it determines the charging timings of the respective electric vehicles. FIG. 4 is a schematic view for describing the distances between the charging station and the respective working areas in the airport. Working areas R1, R2, and R3 correspond to working areas R1, R2, and R3 shown in FIG. 3. As shown in FIG. 4, the distance between the charging station and the working area R1 is denoted by L1, the distance between the charging station and the working area R2 is denoted by L2, and the distance between the charging station and the working area R3 is denoted by L3. In the airport, the working area that is the closest to the charging station is the working area R1 and the working area that is the farthest from the charging station is the working area R3 (i.e., L1<L2<L3).

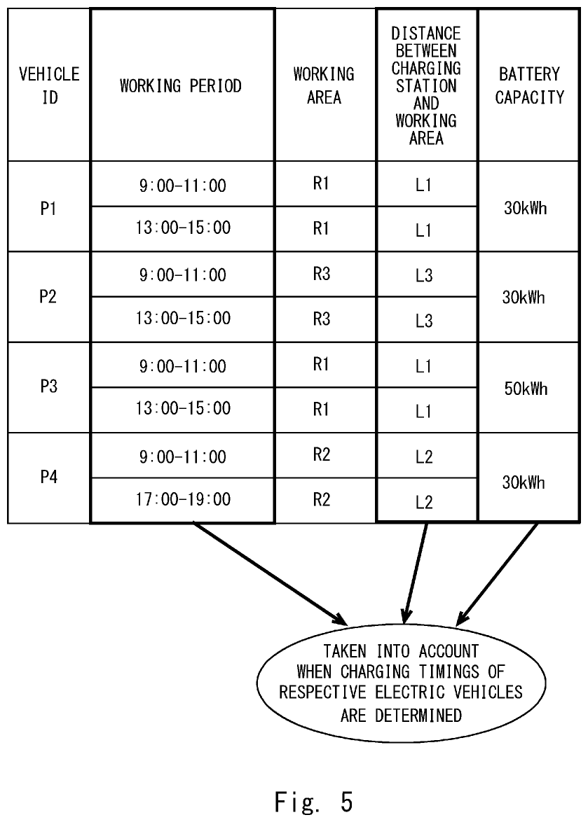

FIG. 5 is a list indicating information that the determination unit 4 (see FIG. 1) takes into account when it determines the charging timings of the respective electric vehicles. As shown in FIG. 5, the determination unit 4 takes into account the working periods and the distances between the charging station and the working areas where the electric vehicles work in the above working periods in the respective electric vehicles when the determination unit 4 determines the charging timings of the respective electric vehicles. When the charging timings of the respective electric vehicles are determined, battery capacities of the respective electric vehicles may be taken into account.

The working period and the battery capacity of the electric vehicle P1 are the same as those of the electric vehicle P2. However, the distance between the charging station and the working area of the electric vehicle P1 is shorter than that of the electric vehicle P2. That is, while it is planned that both the electric vehicle P1 and the electric vehicle P2 conduct working from 9:00 to 11:00 and from 13:00 to 15:00, the distance from the working area (R1) of the electric vehicle P1 to the charging station is shorter than the distance from the working area (R3) of the electric vehicle P2 to the charging station. When the distance between the charging station and the working area is relatively large, charging needs to be performed earlier than charging performed in a case in which the distance between the charging station and the working area is relatively short. This is because, when the distance between the charging station and the working area is relatively large, it takes a longer time for the electric vehicle to move to the charging station than in the case in which the distance between the charging station and the working area is relatively short. Therefore, charging of the electric vehicle P2 is prioritized over charging of the electric vehicle P1.

The working period and the working area of the electric vehicle P1 are the same as those of the electric vehicle P3. However, the battery capacity of the electric vehicle P3 is larger than that of the electric vehicle P1. When the battery capacity is relatively small, charging needs to be performed earlier than charging performed in a case in which the battery capacity is relatively large. This is because the residual capacity of the battery becomes empty earlier in the case in which the battery capacity is relatively small than in the case in which the battery capacity is relatively large. Therefore, charging of the electric vehicle P1 is prioritized over charging of the electric vehicle P3.

In the electric vehicle P4, the interval between the first working and the second working is longer than that in the other electric vehicles (the interval in the other electric vehicles is two hours, whereas the interval in the electric vehicle P4 is six hours). Therefore, charging of the other electric vehicles is prioritized over charging of the electric vehicle P4. From the above description, the charging priority is the highest in the electric vehicle P2, followed by the electric vehicle P1, then the electric vehicle P3, and the electric vehicle P4.

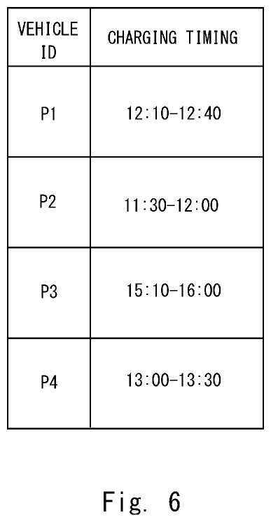

FIG. 6 is a list indicating one example of the charging timings of the respective electric vehicles determined by the determination unit 4 (see FIG. 1). Based on the description given with reference to FIG. 5, as shown in FIG. 6, the electric vehicle P1 performs charging from 12:10 to 12:40, the electric vehicle P2 performs charging from 11:30 to 12:00, the electric vehicle P3 performs charging from 15:10 to 16:00, and the electric vehicle P4 performs charging from 13:00 to 13:30.

When the electric vehicles are for automatic driving, the charging management system 1 sends a charging instruction to a drive control unit of each electric vehicle. Each electric vehicle that has received the charging instruction autonomously moves to the charging station at a predetermined charging timing. On the other hand, when a worker operates the electric vehicle, the charging instruction is sent from the charging management system 1 to the worker via a monitor of each electric vehicle at a predetermined charging timing.

From the above description, in the charging management system 1 according to this embodiment, the charging timings of the respective electric vehicles are determined based on the working plan that the planning unit 3 has created, whereby it is possible to reduce congestion of charging electric vehicles in the airport and improve working efficiency in the airport. By improving the working efficiency in the airport, it is possible to eventually reduce the number of electric vehicles held in the airport.

Note that the present disclosure is not limited to the above embodiment and may be changed as appropriate without departing from the spirit of the present disclosure.

For example, in the above-described embodiments, the charging management system according to the present disclosure has been described as a hardware configuration, but the present disclose is not limited thereto. In the present disclosure, any processing of the charging management system can be achieved by a processor, such as a CPU (Central Processing Unit), loading and executing a computer program stored in a memory.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A charging management system comprising:
a collection unit configured to collect departure and arrival information and information regarding amounts of loads of departing and arriving flights;
a planning unit configured to create a working plan of electric vehicles working in an airport based on the information collected by the collection unit; and
a determination unit configured to determine charging timings of the respective electric vehicles based on the working plan created by the planning unit.

2. The charging management system according to claim 1, wherein
the working plan includes information on working areas and working periods planned in the respective electric vehicles, and
the determination unit takes into account, when determining the charging timings of the respective electric vehicles, the working periods and distances between a charging station and the respective working areas where the respective electric vehicles work in the working periods in the respective electric vehicles.

3. The charging management system according to claim 1, wherein the determination unit takes into account battery capacities of the respective electric vehicles when it determines the charging timings of the respective electric vehicles.
